(19) United States
(12) Patent Application Publication
(10) Pub. No.: US 2025/0376553 A1
(43) Pub. Date: Dec. 11, 2025

(54) HIGHLY ALKALI-STABLE POLY(ARYLENE ALKYLENE PIPERIDINIUM) CATIONIC POLYMERS AND PREPARATION METHODS AND APPLICATIONS

(71) Applicant: Hefei University of Technology, Hefei (CN)

(72) Inventors: Haibing Wei, Hefei (CN); Tao Wang, Hefei (CN); Duoying Chen, Hefei (CN); Yunsheng Ding, Hefei (CN)

(73) Assignee: Hefei University of Technology, Hefei, AH (CN)

(21) Appl. No.: 19/301,037

(22) Filed: Aug. 15, 2025

(30) Foreign Application Priority Data
Aug. 16, 2024 (CN) 202411128857.1

(51) Int. Cl. C08G 10/02

(52) U.S. Cl. CPC C08G 10/02; C08G 2261/143; C08G 2261/1452; C08G 2261/146; C08G 2261/312; C08G 2261/90

(57) ABSTRACT

The present invention relates to the field of cationic polymers, and in particular, to highly alkali-stable poly(arylene alkylene piperidinium) cationic polymers and preparation methods and applications. The preparation method for the highly alkali-stable poly(arylene alkylene piperidinium) cationic polymers includes the following steps: performing catalytic polycondensation on 1-R⁶-piperidine-3-carboxaldehyde or a salt or hydrate thereof and an aromatic compound to obtain a polymer having a piperidine moiety; and then further subjecting the polymer to a quaternization reaction to obtain the poly(arylene alkylene piperidinium) cationic polymer. The anion exchange membranes prepared from the piperidinium-based cationic polymers have ultra-high alkaline stability and excellent mechanical properties and ionic conductivities, and can be applied to the fields of electrochemical energy conversion such as fuel cells, hydrogen production by water electrolysis, electrochemical reduction of carbon dioxide, flow batteries, and fields of separation such as electrodialysis and water treatment.

### TECHNICAL FIELD

The present invention relates to the technical field of cationic polymers, and in particular, to a highly alkali-stable poly(arylene alkylene piperidinium) cationic polymers and preparation methods and applications.

### BACKGROUND

In recent years, anion exchange membrane fuel cell (AEMFC) and anion exchange membrane water electrolysis (AEMWE) in alkaline operating environments have attracted extensive attention from academic and industrial communities due to their lower operating costs and higher electrochemical conversion efficiency comparable to that of acidic counterparts.

However, the alkaline operating environments cause degradation of functional cations in polymer electrolytes in the devices during long-term operation of AEMWE and AEMFC. Cationic polymer electrolytes are mainly used in anion exchange membranes (AEM) and catalytic layer binders. The degradation of their functional cations in alkaline medium directly leads to performance decline of AEMFC and AEMWE. In fact, the main limitation restricting the commercialization of AEMFC and AEMWE is performance degradation during device operation. Therefore, developing polymer electrolytes with a high degree of alkaline stability is crucial for improving the operational durability of AEMFC and AEMWE.

Through the efforts of numerous researchers, poly(arylene piperidinium) polymers are currently the most promising polymer electrolytes applied to alkaline electrochemical conversion devices. However, by directly linking the piperidinium rings to the aromatic units, 3-H Hofmann elimination of piperidinium cation groups is activated under high alkali concentration conditions, which weakens their alkaline resistance to a certain extent (ChemSusChem 2024, 17, e202301656). Therefore, it is urgent to improve the alkaline stability of piperidinium-based polymer electrolytes while maintaining other advantages through structural design.

### SUMMARY

The purpose of the present invention is to provide highly alkali-stable poly(arylene alkylene piperidinium) cationic polymers and preparation methods and applications. The alkaline stability and mechanical strength of the poly(arylene alkylene piperidinium) cationic polymer are improved, while ensuring their excellent electrochemical performance.

To achieve the above purpose, the present invention provides highly alkali-stable poly(arylene alkylene piperidinium) cationic polymers, and the cationic polymers includes the following structural units:

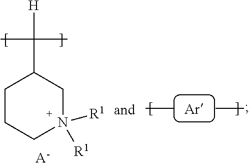

in the formula, R¹ is selected from an H atom or a hydrocarbyl group with 1-20 carbon atoms, or R¹ groups are connected to each other to form a cycloalkyl group consisting essentially of 4 to 10 carbon atoms; the counterion A⁻ is selected from one or more of halide ions, methyl sulfate ions, hydroxide ions, and bicarbonate ions; and
the Ar′ unit is selected from one or more of the following structures:

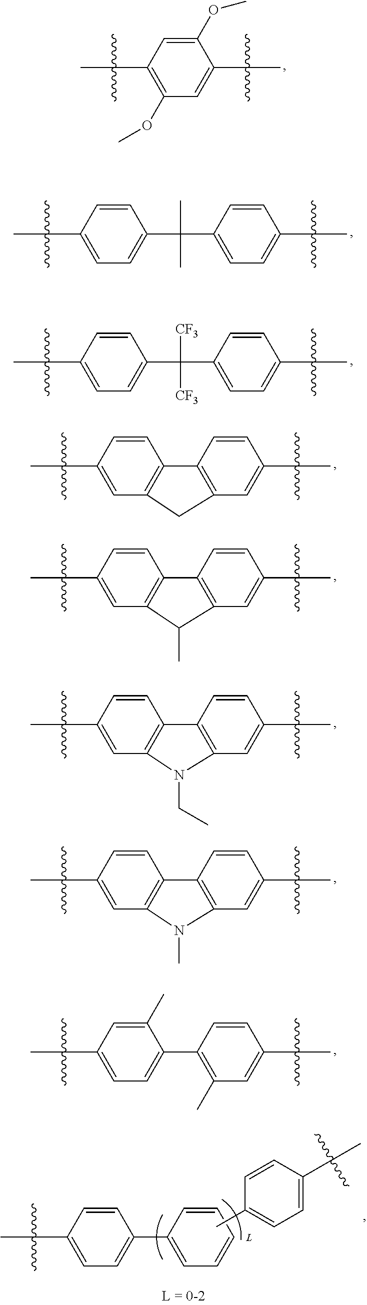

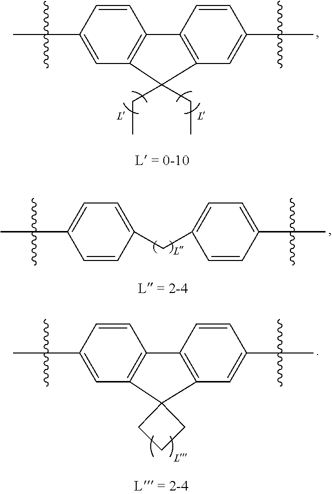

Preferably, in addition to the above structural units, the poly(arylene alkylene piperidinium) cationic polymers may further include one or more of the following structural units:

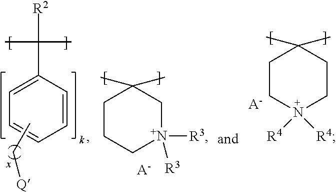

in the formulae, k=0 or 1; x=0-12;

R² is independently selected from an H atom or a hydrocarbyl group with 1-20 carbon atoms, and a fully or partially fluorinated alkyl group with 1-6 carbon atoms;

Q′ is selected from one or more of an H atom, —N⁺(R⁵)₃, or a nitrogen heterocycle-containing cation, and the counterion A is selected from halide ions, methyl sulfate ions, hydroxide ions, or bicarbonate ions; and
R³ and R⁴ are each independently selected from an H atom or a hydrocarbon group with 1-20 carbon atoms, or independent R³ groups are connected to each other to form a cycloalkyl group consisting essentially of 4 to 10 carbon atoms, or independent R⁴ groups are connected to each other to form a cycloalkyl group consisting essentially of 4 to 10 carbon atoms;
more preferably, in —N⁺(R⁵)₃, each R⁵ is independently selected from a hydrocarbyl group with 1-20 carbon atoms;
the nitrogen heterocycle-containing cation includes one or more of partially or fully substituted pyrazolium, pyrrolidinium, piperidinium, imidazolium, and quinuclidinium, with the structural formulae as follows:

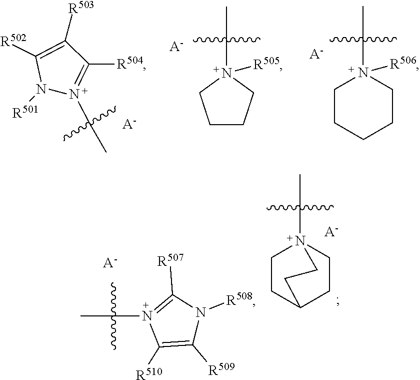

in the formula, R⁵⁰¹-R⁵¹⁰ are each independently selected from a hydrocarbyl group with 1-20 carbon atoms, and the counterion A⁻ is selected from one or more of halide ions, methyl sulfate ions, hydroxide ions, and bicarbonate ions.

The present invention further provides a preparation method for the highly alkali-stable poly(arylene alkylene piperidinium) cationic polymers, including the following steps:
S1, mixing 1-R⁶-piperidine-3-carboxaldehyde or its salt or hydrate thereof with aromatic compounds to obtain a polymerization compound mixture, placing the polymerization compound mixture in a first organic solvent, adding a strong organic acid for catalytic polycondensation, and allowing the mixture to react at −20-100° C. for 0.01-100 h to obtain a polymer dispersion with piperidine moieties;
in the S1, the aromatic compound has one or more of the following structures:

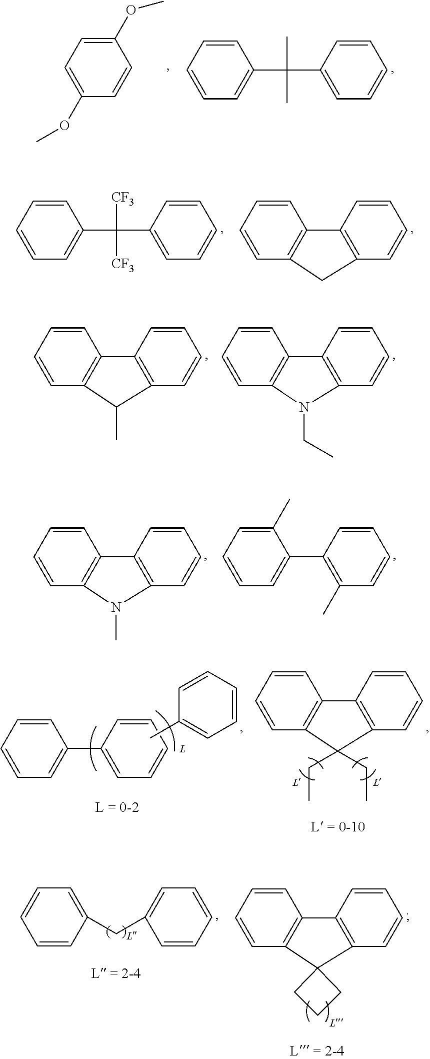

S2, slowly dropping the polymer dispersion with the piperidine moiety in the S1 into a first precipitant, filtering, washing, and drying to obtain a polymer powder with piperidine moieties;
S3, dissolving the polymer powder with the piperidine structure in the S2 in a second organic solvent to obtain a mixture, adding quaternization reagents into the mixture, obtaining a cationic polymer solution after a quaternization reaction at 0-100° C. for 0.1-100 h; and
S4, slowly adding the cationic polymer solution in the S3 into a second precipitant, filtering and drying the filtered precipitate to obtain a poly(arylene alkylene piperidinium) cationic polymer powder.

Preferably, in the S1, a structural formula of the 1-R⁶-piperidine-3-carboxaldehyde is shown as follows:

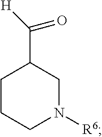

in the formula, R⁶ is selected from one or more of an H atom or a hydrocarbyl group with 1-20 carbon atoms.

More preferably, in the S1, the 1-R⁶-piperidine-3-carboxaldehyde or a salt or hydrate thereof includes one or more of 1-R⁶-piperidine-3-carbaldehyde, 1-R⁶-piperidine-3-carbaldehyde hydrochloride, 1-R⁶-piperidine-3-carbaldehyde hydrofluoride, 1-R⁶-piperidine-3-carbaldehyde hydrobromide, 1-R⁶-piperidine-3-carbaldehyde hydroiodide, 1-R⁶-piperidine-3-carbaldehyde trifluoroacetate, 1-R⁶-piperidine-3-carbaldehyde acetate, 1-R⁶-piperidine-3-carbaldehyde trifluoromethanesulfonate, 1-R⁶-piperidine-3-carbaldehyde methanesulfonate, 1-R⁶-piperidine-3-carbaldehyde sulfate, 1-R⁶-piperidine-3-carbaldehyde nitrate, 1-R⁶-piperidine-3-carbaldehyde tetrafluoroborate, 1-R⁶-piperidine-3-carbaldehyde hexafluorophosphate, 1-R⁶-piperidine-3-carbaldehyde formate, 1-R⁶-piperidine-3-carbaldehyde benzenesulfonate, 1-R⁶-piperidine-3-carbaldehyde toluate, 1-R⁶-piperidine-3-carbaldehyde perchlorate, 1-R⁶-piperidine-3-carbaldehyde benzoate, and hydrates of the above salts.

Preferably, in the S1, the polymerization compound mixture further includes carbonyl monomers, and the carbonyl monomers have one or more of the following structures:

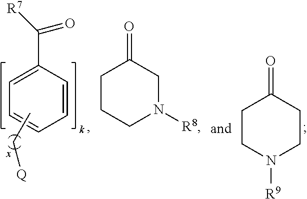

in the formula, k=0 or 1; x=0-12;
Q is selected from one or more of an H atom or a halogen atom;
R⁷ is selected from one or more of an H atom, a hydrocarbyl group with 1-20 carbon atoms, or fully or partially fluorinated alkyl groups with 1-6 carbon atoms; and
R⁸ and R⁹ are each independently selected from an H atom or a hydrocarbyl group with 1-20 carbon atoms.

Preferably, in the S1, the molar ratio of the 1-R⁶-piperidine-3-carboxaldehyde or a salt or hydrate thereof to the strong organic acid is 1:(1-20).

Preferably, in the S1, the ratio of sum of the molar amounts of 1-R⁶-piperidine-3-carboxaldehyde or a salt or hydrate thereof and carbonyl monomers to the molar amounts of strong organic acid is 1:(1-20).

Preferably, in the S1, the first organic solvent is one or more of dichloromethane, chloroform, carbon tetrachloride, dichloroethane, nitromethane, or nitrobenzene.

The strong organic acid is at least one of methanesulfonic acid, trifluoromethanesulfonic acid, and trifluoroacetic acid.

Preferably, in the S2, the first precipitant is one or more of water, ethanol, methanol, and isopropanol.

Preferably, in the S3, the second organic solvent is at least one of polar aprotic solvents from dimethyl sulfoxide, N-methylpyrrolidone, N,N-dimethylacetamide, or N,N-dimethylformamide.

Preferably, in the S3, the quaternization reagent is dimethyl sulfate or halogenated hydrocarbons with 1-20 carbon atoms, with the structure of:

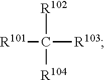

in the formula, R¹⁰¹, R¹⁰², R¹⁰³, and R¹⁰⁴ are each independently selected from hydrogen, halogen, hydrocarbyl groups or halohydrocarbyl groups with 1-20 carbon atoms, or aryl groups or halogenated aryl groups with 1-20 carbon atoms, and the halohydrocarbyl group or halogenated aryl group contains at least one halogen atom.

Preferably, the molar ratio of piperidine groups of the polymer comprising the piperidine structure to the quaternization reagent is 1:(1-10).

Preferably, one or more of potassium carbonate, potassium hydroxide, sodium carbonate, sodium bicarbonate, or sodium hydroxide can be added in the S3.

Preferably, in the S4, the second precipitant is one or more of water, acetone, diethyl ether, toluene, ethyl acetate, or petroleum ether.

Preferably, the poly(arylene alkylene piperidinium) cationic polymer powder is immersed in a solution containing other types of counterions for ion exchange to obtain a cationic polymer containing other types of counterions.

More preferably, the other types of counterions are at least one of hydroxide ions, carbonate ions, bicarbonate ions, sulfate ions, or halide ions different from the counterion A⁻.

More preferably, the concentration of the solution containing other types of counterions is 0.01-10 mol/L.

Use of the highly alkali-stable poly(arylene alkylene piperidinium) cationic polymers, where the highly alkali-stable poly(arylene alkylene piperidinium) cationic polymer is used in anion exchange membranes or the catalyst layer binders.

Preferably, the preparation method for anion exchange membranes includes: dissolving the highly alkali-stable poly(arylene alkylene piperidinium) cationic polymers in a third organic solvent to obtain a cationic polymer solution, coating onto a substrate with the polymer solution, drying the polymer solution to remove the third organic solvent, peeling off the membrane, and washing the membrane to obtain the anion exchange membrane.

Preferably, a coating method is one of solution casting, spin coating, doctor blading, tape casting, or dip coating; a method for removing the solvent is volatilization at room temperature or heating at 30-100° C.

Preferably, the third organic solvent is a polar aprotic solvent, specifically, at least one or more of dimethyl sulfoxide, N-methylpyrrolidone, N,N-dimethylacetamide, or N,N-dimethylformamide.

Preferably, a preparation method for catalyst layer binders includes: dissolving or dispersing the highly alkali-stable poly(arylene alkylene piperidinium) cationic polymers in a fourth organic solvent to obtain catalyst layer binders solutions or dispersions, and uniformly mixing the catalyst layer binders solutions or dispersions with a catalyst to obtain a slurry using the cationic polymer as the catalyst layer binders.

Preferably, the fourth organic solvent is a low-boiling-point solvent, and more preferably, at least one of water, methanol, ethanol, n-propanol, isopropanol, or n-butanol.

Preferably, a concentration of the poly(arylene alkylene piperidinium) cationic polymer is 1-99 wt %, more preferably 1-75 wt %, and further preferably 1-40 wt %.

The principle of the present invention is as follows:

By linking the piperidinium cations to phenylene-based backbones through alkylene spacer groups, on the one hand, the number of β-hydrogen atoms on the piperidinium ring is reduced from 4 to 3; on the other hand, the influence of the electron-withdrawing effect of the benzene ring on the β-hydrogen on the piperidinium ring is mitigated, such that the probability of Hofmann elimination of the piperidinium cations in the polymer is greatly reduced, thereby greatly improving the alkaline stability of such piperidinium-containing polymer. In addition, the polymerization reaction is easier to occur due to the high reactivity of the aldehyde group, such that the molecular weight of the ionomer increases, which will improve the mechanical properties of the highly alkaline-stable poly(arylene alkylene piperidinium) cationic polymer.

Therefore, by adopting the above technical solution, the present disclosure has the following beneficial effects:

1. The highly alkaline-stable poly(arylene alkylene piperidinium) cationic polymers provided by the present invention has ultra-high alkaline stability. By linking the piperidinium cations to the arylene units through flexible spacer groups, the alkaline stability of the cationic polymers is greatly improved. When applied to the anion exchange membranes or catalyst layer binder materials, the cationic polymer exhibits excellent alkaline stability;

2. The preparation method for the highly alkali-stable poly(arylene alkylene piperidinium) cationic polymers provided by the present invention is simple and mild, and suitable for scaled production;

3. The aldehyde monomer used in the reaction system for the highly alkali-stable poly(arylene alkylene piperidinium) cationic polymers provided by the present invention e is highly reactive, such that the synthetic efficiency of the poly(arylene alkylene piperidinium) cationic polymers with a high molecular weight is improved;

4. The cationic polymers prepared by the present invention may be used as a separator material in many fields such as fuel cells and water electrolysis, and moreover, the cationic polymers may also be used as the catalyst binder material in catalyst layers for fuel cells and water electrolysis;

5. The anion exchange membrane prepared from the piperidinium-based cationic polymer provided by the present invention has ultra-high alkaline stability, excellent mechanical properties and ionic conductivity, and can be applied to the fields of electrochemical energy conversion, such as fuel cells, hydrogen production by water electrolysis, electrochemical reduction of carbon dioxide, and flow batteries, and the fields of separation, such as electrodialysis and water treatment.

The technical solution of the present invention will be further described in detail with reference to drawings and embodiments.

### BRIEF DESCRIPTION OF THE DRAWINGS

FIG. 1 is the ¹H NMR spectrum of PBMP in Test Example 1 of the present invention.

FIG. 2 is ¹H NMR spectra of PBMP and a conventional cationic polymer PBP before and after alkaline hydrolysis in Test Example 1 of the present invention.

FIG. 3 shows temperature-dependent hydroxide ion conductivities—of the anion exchange membrane II in Application Example 2 of the present invention.

FIG. 4 shows temperature-dependent water uptake of the anion exchange membrane II in Application Example 2 of the present invention.

FIG. 5 shows temperature-dependent swelling ratio of the anion exchange membrane II in Application Example 2 of the present invention.

FIG. 6 is the electrochemical performance graph of a catalyst layer binder and the anion exchange membrane II prepared from a poly(arylene alkylene piperidinium) cationic polymer in Example 2 of the present invention.

### DETAILED DESCRIPTIONS OF THE EMBODIMENTS

The present invention will be further described below with reference to the drawings and examples. Unless otherwise defined, the technical or scientific terms used herein shall have the ordinary meanings as understood by those of ordinary skill in the art to which the present invention pertains. The features mentioned in the present invention or the features mentioned in the specific examples can be combined arbitrarily, and these specific examples are only used to illustrate the present invention, rather than limiting the scope of the present invention.

### Example 1

S1, a polymerization mixture consisting of 3-piperidinecarboxaldehyde hydrochloride (0.17 g, 1.16 mmol) and biphenyl (0.16 g, 1.05 mmol) was placed in dichloromethane (1.7 mL), trifluoromethanesulfonic acid (2.5 mL) was added for catalytic polycondensation, and the mixture was allowed to react at 22° C. for 10 h to obtain a viscous dispersion of a polymer having piperidine moieties.

S2, the dispersion of the polymer having a piperidine structure in the S1 was slowly dropped into a 1:1 (v/v) mixed solution of methanol and water, and the obtained pale yellow fibrous polymer was filtered, washed thoroughly, and vacuum-dried to obtain 0.25 g of a white fibrous polymer powder having piperidine moieties.

S3, the polymer powder having piperidine moieties in S2 was dissolved in 3 mL of N-methylpyrrolidone to obtain a mixture, 0.26 mL of methyl iodide and 0.15 g of potassium carbonate were added into the mixture, and the resulting mixture was subjected to a quaternization reaction at room temperature for 72 h to obtain a cationic polymer solution.

S4, the cationic polymer solution in S3 was slowly added into diethyl ether to obtain a mixture, and the mixture was filtered and the filtered precipitate was dried to obtain a 0.26 g of highly alkali-stable poly(arylene alkylene piperidinium) cationic polymer powder, with the structure shown as follows:

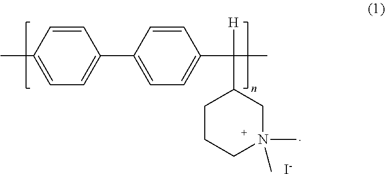

### Application Example 1

a. Preparation of an Anion Exchange Membrane

The highly alkali-stable poly(arylene alkylene piperidinium) cationic polymer powder prepared in Example 1 was dissolved in 3 mL of dimethyl sulfoxide to obtain a poly(arylene alkylene piperidinium) cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off thoroughly washed with deionized water to obtain an anion exchange membrane I with counterions I⁻.

b. Replacement of the Counterions in the Anion Exchange Membrane I

Anions in the anion exchange membrane I with counterions I⁻ prepared in the step a were exchanged as needed, the anion exchange membrane I with counterions I⁻ was placed in a 2 mol/L NaCl solution and immersed for 24 h, and then the membrane was thoroughly washed with deionized water to obtain the anion exchange membrane I with counterions Cl⁻.

c. Preparation of Catalyst Layer Binder

The counterions in the poly(arylene alkylene piperidinium) cationic polymer prepared in Example 1 were exchanged as needed, the poly(arylene alkylene piperidinium) cationic polymer powder prepared in Example 1 was placed in a 2 mol/L NaOH solution and immersed for 48 h to obtain a mixture, and then the mixture was thoroughly washed with deionized water, and subjected to suction filtration to obtain the poly(arylene alkylene piperidinium) cationic polymer with counterions OH⁻.

The poly(arylene alkylene piperidinium) cationic polymer with counterions OH⁻ was dissolved in a mixed solvent of isopropanol and water with a solid content of 2 wt % and mixed with a metal catalyst to prepare a uniformly dispersed slurry, i.e., a slurry of the catalyst layer binder based on the poly(arylene alkylene piperidinium) cationic polymer in Example 1.

### Test Example 1

a. Nuclear Magnetic Resonance Hydrogen Spectrum

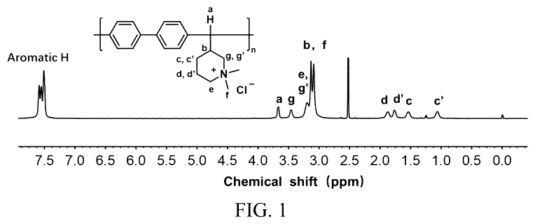

The counterions in the highly alkali-stable poly(arylene alkylene piperidinium) cationic polymer having a structure shown in formula (1) were modified to obtain the highly alkali-stable poly(arylene alkylene piperidinium) cationic polymer PBMP with counterions Cl⁻. By using DMSO-d₆ as a solvent, the PBMP was detected by an Agilent 600 MHz nuclear magnetic resonance spectrometer, and results were shown in FIG. 1. It could be known that PBMP was successfully prepared.

b. Test of Alkaline Stability

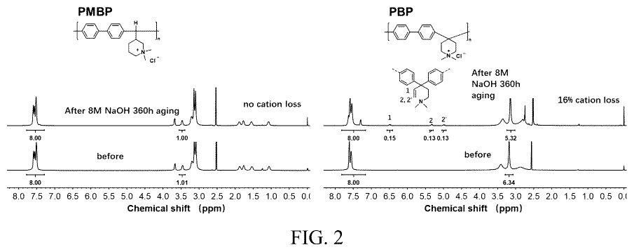

After alkaline hydrolysis of the PBMP and cationic polymer PBP (the chemical structural formula was shown in FIG. 2) which had been evaluated in an 8 mol L⁻¹ NaOH aqueous solution at 80° C. for 360 h, the ¹H NMR spectra of before and after alkaline hydrolysis were shown in FIG. 2. It may be known that after the alkaline hydrolysis of the PBMP for 360 h, the poly(arylene alkylene piperidinium) cationic polymer are not degraded. In FIG. 2, no obvious chemical shift changes or newly emerged signal peaks are observed, indicating that the PBMP has prominent alkaline stability. On the other hand, the conventional cationic polymer PBP with the 4-position of the piperidinium cation directly linked to the aromatic ring has 16% ion loss after alkaline treatment, and the main degradation pathway is Hofmann elimination reaction. It may be seen that the highly alkali-stable poly(arylene alkylene piperidinium) cationic polymer provided by the present invention has prominent alkaline stability.

### Example 2

S1, a polymerization mixture consisting of 3-piperidinecarboxaldehyde hydrochloride (0.17 g, 1.16 mmol), biphenyl (0.3 g, 1.96 mmol), and trifluoroacetone (0.09 g, 0.86 mmol) was placed in dichloromethane (2.0 mL), trifluoromethanesulfonic acid (3.0 mL) was added for catalytic polycondensation, and the mixture was allowed to react at 0° C. for 10 h to obtain a viscous dispersion of a polymer having piperidine moieties.

S2, the dispersion of the polymer having a piperidine structure in the S1 was slowly dropped into a 1:1 (v/v) mixed solution of methanol and water, and the obtained pale yellow fibrous polymer was filtered, washed thoroughly, and vacuum-dried to obtain 0.44 g of a white fibrous polymer powder having piperidine moieties.

S3, the polymer powder having piperidine moieties in the S2 was dissolved in 5 mL of N-methylpyrrolidone to obtain a mixture, 0.49 mL of methyl iodide and 0.2 g of potassium carbonate were added into the mixture, and the resulting mixture was subjected to a quaternization reaction at room temperature for 72 h to obtain a cationic polymer PBMP-60 solution.

S4, the cationic polymer solution in the S3 was slowly added into diethyl ether to obtain a mixture, the mixture was filtered, and the filtered precipitate was dried to obtain 0.50 g of a highly alkali-stable poly(arylene alkylene piperidinium) cationic polymer PBMP-60 powder, with the structure shown as follows:

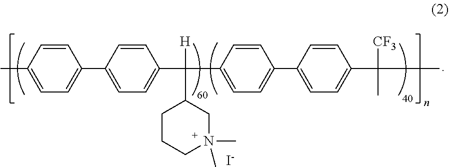

### Application Example 2

a. Preparation of an Anion Exchange Membrane

The highly alkali-stable poly(arylene alkylene piperidinium) cationic polymer powder prepared in Example 2 was dissolved in 5 mL of dimethyl sulfoxide to obtain a poly(arylene alkylene piperidinium) cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off and thoroughly washed with deionized water to obtain an anion exchange membrane II with counterions I⁻.

b. Replacement of the Counterions in the Anion Exchange Membrane II with Counterions I⁻

The anion exchange membrane II with counterions I⁻ was placed in a 1 mol/L NaOH solution and immersed for 48 h, and then the anion exchange membrane II was thoroughly washed with deionized water to obtain the anion exchange membrane II with counterions OH⁻.

c. Preparation of a Catalytic Layer Binder

The counterions in the PBMP-60 prepared in Example 2 were exchanged as needed, the PBMP-60 powder prepared in Example 2 was placed in a 2 mol/L NaOH solution and immersed for 48 h to obtain a mixture, and then the mixture was thoroughly washed with deionized water, and subjected to suction filtration to obtain the catalyst layer binder with counterions OH⁻.

The prepared catalytic layer binder with counterions OH⁻ was dissolved in a mixed solvent of isopropanol and water with a solid content of 2 wt % and mixed with a metal catalyst to prepare a uniformly dispersed slurry which was a slurry of the catalyst layer binder based on the PBMP-60 in Example 2.

### Test Example 2

The anion exchange membrane II and the catalyst layer binder in Application Example 2 are tested to characterize their basic performance.

### (1) Hydroxide Ion Conductivity

The hydroxide ion conductivity was tested by an alternating current impedance method based on four electrodes. The anion exchange member II with counterions OH⁻ was cut into 1 cm×5 cm splines, then the splines were fixed on a clamp, and the clamp was placed in a water tank containing pure water. Electrodes were mounted and connected to an electrochemical workstation. In a constant current mode (0.1 mA), the scanning frequency range was 1 MHz-100 Hz, a frequency range with stable impedance was found on a Bode curve, and then resistance R of the anion exchange membrane II with counterions OH⁻ was read on the corresponding curve.

The hydroxide ion conductivity is calculated by the following formula:

$$σ = \frac{L}{R \times w \times d} ;$$

in the formula, R is resistance of the anion exchange membrane II with counterions OH⁻, L is a distance (1.0 cm) between the electrodes, W is a width of the anion exchange membrane II with counterions OH⁻, and d is a thickness of the anion exchange membrane II with counterions OH⁻.

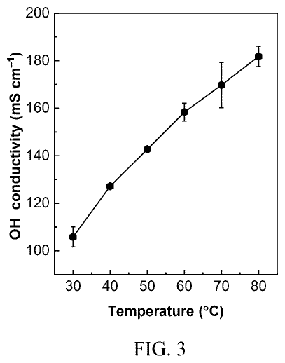

The temperature-dependent hydroxide ion conductivities of the anion exchange membrane II with counterions OH⁻ is obtained by calculating the hydroxide ion conductivities at different temperatures, as shown in FIG. 3. It may be known from FIG. 3 that at 80° C., the hydroxide ion conductivity of the anion exchange membrane II with counterions OH⁻ reaches 182 mS cm⁻¹.

### (2) Water Uptake and Swelling Ratio

The anion exchange membrane II with counterions OH⁻ was cut into 1 cm×8 cm splines, the splines were thoroughly dried in an oven, the weight of the dried anion exchange membrane II was denoted as W_{dry}, then the dried anion exchange membrane II was immersed in deionized water, the anion exchange membrane II was taken out every 12 h, water on the surface of the anion exchange membrane II was wipe-dried, and the weights W_{wet} of the anion exchange membrane II immersed at different temperatures (30-80° C.) were recorded.

The water uptake (WU) is calculated by the following formula:

$$WU = \frac{{W}_{wet} - {W}_{dry}}{{W}_{dry}} \times 1 \; 00 \% .$$

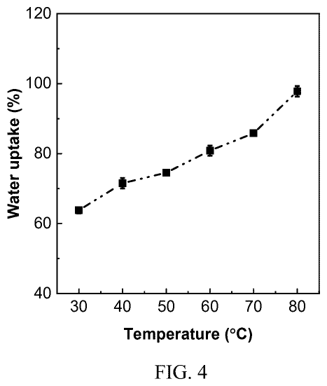

The temperature-dependent water uptake of the anion exchange membrane II with counterions OH⁻ is obtained by calculating the water uptakes at different temperatures, as shown in FIG. 4.

The swelling ratio (SR) is an important indicator that measures the dimensional stability of the membrane, and is calculated through lengths (L_{dry}) and (L_{wet}) of the anion exchange membrane II in dry and wet states by the following formula:

$$SR = \frac{{L}_{wet} - {L}_{dry}}{{L}_{dry}} \times 100 \% .$$

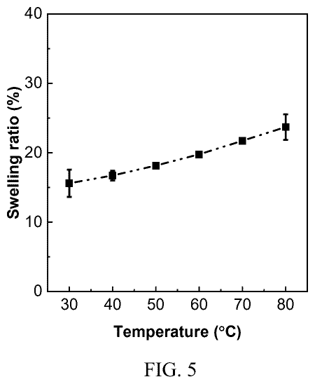

The temperature-dependent swelling ratio of the anion exchange membrane II is obtained by calculating the swelling ratios at different temperatures, as shown in FIG. 5.

### (3) Electrochemical Performance

The catalyst layer binder and the anion exchange membrane II were respectively prepared from the PBMP-60 in Example 2. Pt/C was used as cathode and anode catalysts, the loading of Pt in the anode and cathode was 0.5 mg cm⁻², and a membrane electrode was prepared by the catalyst-coated membrane technology.

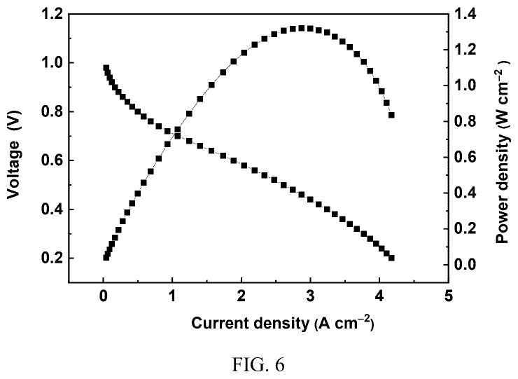

An H₂—O₂ fuel cell test was performed at 80° C., where the gas flow rate was 350 mL min⁻¹, the back pressure of H₂/O₂ was 200 kPa, the relative humidity (RH) was 100%, and electrochemical performance of the catalyst layer binder and the anion exchange membrane II prepared from the PBMP-60 in Example 2 was detected, as shown in FIG. 6.

To sum up, at 80° C., the hydroxide ion conductivity of the anion exchange membrane II reaches 182 mS cm 1, the anion exchange membrane II has moderate water uptake and swelling ratio, and the peak power density of the membrane electrode formed by the PBMP-60 reaches 1.32 W cm⁻².

### Example 3

S1, a polymerization mixture consisting of 3-piperidinecarboxaldehyde hydrochloride (0.21 g, 1.45 mmol) and p-terphenyl (0.3 g, 1.32 mmol) was placed in dichloromethane (1.3 mL), trifluoromethanesulfonic acid (2.0 mL) was added for catalytic polycondensation, and the mixture was allowed to react at 22° C. for 14 h to obtain a viscous dispersion of a polymer having piperidine moieties.

S2, the dispersion of the polymer having a piperidine structure in the S1 was slowly dropped into a 1:1 (v/v) mixed solution of methanol and water, and the obtained pale yellow fibrous polymer was filtered, washed thoroughly, and vacuum-dried to obtain 0.42 g of a white fibrous polymer powder having piperidine moieties.

S3, the polymer powder having piperidine moieties in the S2 was dissolved in 4 mL of N-methylpyrrolidone to obtain a mixture, 0.50 mL of methyl iodide and 0.2 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.55 g of a highly alkali-stable poly(arylene alkylene piperidinium) cationic polymer powder, with the structure shown as follows:

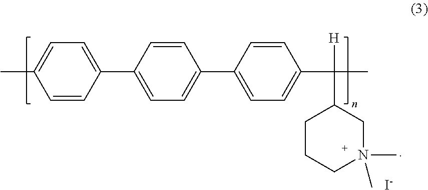

### Application Example 3

a. Preparation of an Anion Exchange Membrane

The highly alkali-stable poly(arylene alkylene piperidinium) cationic polymer powder prepared in Example 3 was dissolved in 5.5 mL of dimethyl sulfoxide to obtain a cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off thoroughly washed with deionized water to obtain an anion exchange membrane III with counterions I⁻.

b. Replacement of the Counterions in the Anion Exchange Membrane III

Anions in the anion exchange membrane III with counterions I⁻ prepared in the step a were exchanged as needed, the anion exchange membrane III with counterions I⁻ was placed in a 2 mol/L NaCl solution and immersed for 48 h, and then the membrane was thoroughly washed with deionized water to obtain the anion exchange membrane III with counterions Cl⁻.

c. Preparation of a Catalyst Layer Binder

The counterions in the poly(arylene alkylene piperidinium) cationic polymer prepared in Example 3 were exchanged as needed, the poly(arylene alkylene piperidinium) cationic polymer powder prepared in Example 3 was placed in a 2 mol/L NaOH solution and immersed for 48 h to obtain a mixture, and then the mixture was thoroughly washed with deionized water, and subjected to suction filtration to obtain the poly(arylene alkylene piperidinium) cationic polymer with counterions OH⁻.

The poly(arylene alkylene piperidinium) cationic polymer with counterions OH⁻ was dissolved in a mixed solvent of isopropanol and water with a solid content of 2 wt % and mixed with a metal catalyst to prepare a uniformly dispersed slurry which is a slurry using the poly(arylene alkylene) piperidinium cationic polymer in Example 3 as a catalyst layer binder.

### Example 4

S1, a polymerization mixture consisting of 3-piperidinecarboxaldehyde hydrochloride (0.1 g, 0.72 mmol), p-terphenyl (0.3 g, 1.32 mmol), and p-cyanobenzaldehyde (0.1 g, 0.72 mmol) was placed in dichloromethane (0.9 mL), trifluoromethanesulfonic acid (1.0 mL) was added for catalytic polycondensation, and the mixture was allowed to react at 0° C. for 5 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.34 g of a white fibrous polymer powder having piperidine moieties.

S3, the polymer powder having piperidine moieties in the S2 was dissolved in 4 mL of N-methylpyrrolidone to obtain a mixture, 0.18 mL of methyl iodide and 0.12 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.36 g of a highly alkali-stable poly(arylene alkylene piperidinium) cationic polymer powder, with the structure shown as follows:

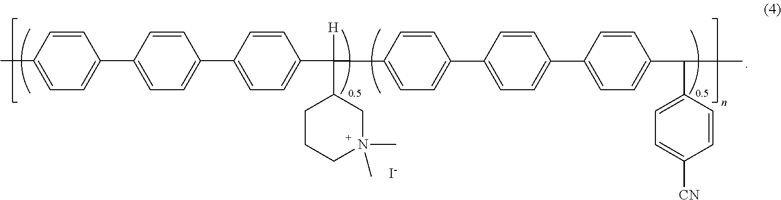

### Application Example 4

a. Preparation of an Anion Exchange Membrane

The highly alkali-stable poly(arylene alkylene piperidinium) cationic polymer powder prepared in Example 4 was dissolved in 3 mL of dimethyl sulfoxide to obtain a cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off and thoroughly washed with deionized water to obtain an anion exchange membrane IV with counterions I⁻.

b. Replacement of the Counterions in the Anion Exchange Membrane IV

Anions in the anion exchange membrane IV with counterions I⁻ prepared in the step a were exchanged as needed, the anion exchange membrane III with counterions I⁻ was placed in a 2 mol/L NaCl solution and immersed for 48 h, and then the membrane was thoroughly washed with deionized water to obtain the anion exchange membrane IV with counterions Cl⁻.

### Example 5

S1, a polymerization mixture consisting of 3-piperidinecarboxaldehyde hydrochloride (0.10 g, 0.73 mmol), p-terphenyl (0.3 g, 1.32 mmol), and 1-piperidin-3-one hydrochloride (0.10 g, 0.73 mmol) was placed in dichloromethane (4 mL), trifluoromethanesulfonic acid (6.0 mL) was added for catalytic polycondensation, and the mixture was allowed to react at 0° C. for 22 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.45 g of a white fibrous polymer powder having piperidine moieties.

S3, the polymer powder having piperidine moieties in the S2 was dissolved in 4 mL of N-methylpyrrolidone to obtain a mixture, 0.44 mL of methyl iodide and 0.23 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.52 g of a highly alkali-stable poly(arylene alkylene piperidinium) cationic polymer powder, with the structure shown as follows:

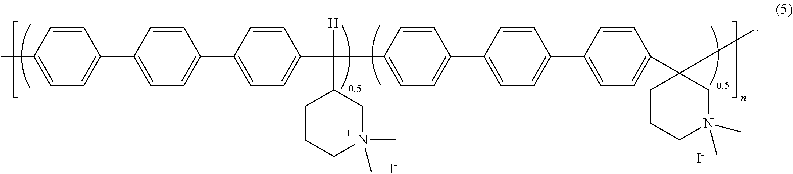

### Application Example 5

a. Preparation of an Anion Exchange Membrane

The highly alkali-stable poly(arylene alkylene piperidinium) cationic polymer powder prepared in Example 5 was dissolved in 5 mL of dimethyl sulfoxide to obtain a poly(arylene alkylene piperidinium) cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off and thoroughly washed with deionized water to obtain an anion exchange membrane V with counterions I⁻.

b. Replacement of the Counterions in the Anion Exchange Membrane V

Anions in the anion exchange membrane V with counterions I⁻ prepared in the step a were exchanged as needed, the anion exchange membrane V with counterions I⁻ was placed in a 2 mol/L NaCl solution and immersed for 48 h, and then the membrane was thoroughly washed with deionized water to obtain the anion exchange membrane V with counterions Cl⁻.

### Example 6

S1, a polymerization mixture consisting of 3-piperidinecarboxaldehyde hydrochloride (0.20 g, 1.43 mmol) and biphenyl (0.20 g, 1.32 mmol) was placed in dichloromethane (4.0 mL), trifluoromethanesulfonic acid (5.2 mL) was added for catalytic polycondensation, and the mixture was allowed to react at 22° C. for 2 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.35 g of a white fibrous polymer powder having piperidine moieties.

S3, the polymer powder having piperidine moieties in the S2 was dissolved in 4 mL of N-methylpyrrolidone to obtain a mixture, 0.015 mL of methyl iodide and 0.2 g of potassium carbonate were added into the mixture, and the resulting mixture was subjected to a quaternization reaction at room temperature for 72 h, and then 0.1 g of 1,6-dibromohexane was added to obtain a cationic polymer solution.

S4, the cationic polymer solution in the S3 was slowly added into diethyl ether to obtain a mixture, the mixture was filtered, and the filtered precipitate was dried to obtain 0.44 g of a highly alkali-stable poly(arylene alkylene piperidinium) cationic polymer powder, with the structure shown as follows:

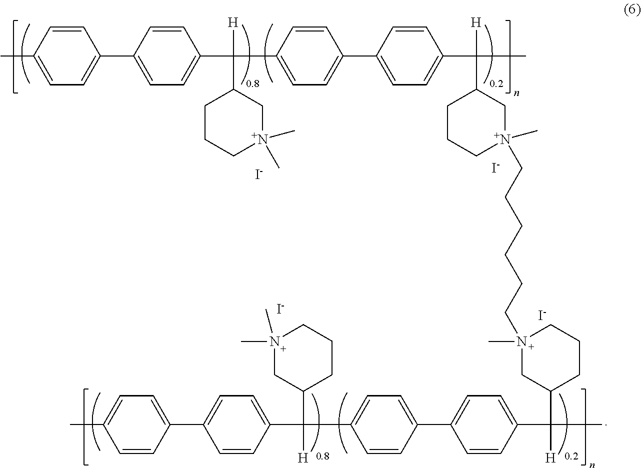

### Application Example 6

a. Preparation of an Anion Exchange Membrane

The highly alkali-stable poly(arylene alkylene piperidinium) cationic polymer powder prepared in Example 6 was dissolved in 4 mL of dimethyl sulfoxide to obtain a poly(arylene alkylene piperidinium) cationic polymer solution with a mass fraction of about 10%. A clean glass plate was coated with the poly(arylene alkylene piperidinium) cationic polymer solution by a tape casting method, and the glass plate was placed in a blast drying oven at 80° C. and dried for 24 h to remove dimethyl sulfoxide. When the temperature was decreased to room temperature, the glass plate was taken out and placed in deionized water, and the membrane was peeled off and thoroughly washed with deionized water to obtain an anion exchange membrane VI with counterions I⁻.

b. Replacement of the Counterions in the Anion Exchange Membrane VI

Anions in the anion exchange membrane VI with counterions I⁻ prepared in the step a were exchanged as needed, the anion exchange membrane VI with counterions I⁻ was placed in a 2 mol/L NaCl solution and immersed for 48 h, and then the membrane was thoroughly washed with deionized water to obtain the anion exchange membrane VI with counterions Cl⁻.

### Example 7

S1, a polymerization mixture consisting of 3-piperidinecarboxaldehyde hydrochloride (0.20 g, 1.43 mmol), spiro(cyclohexane-1,9′-fluorene) (0.16 g, 0.65 mmol), and 9,9-dimethylfluorene (0.13 g, 0.65 mmol) was placed in dichloromethane (3 mL), trifluoromethanesulfonic acid (4.0 mL) was added for catalytic polycondensation, and the mixture was allowed to react at 22° C. for 10 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.43 g of a white fibrous polymer powder having piperidine moieties.

S3, the polymer powder having piperidine moieties in the S2 was dissolved in a 5 mL of N-methylpyrrolidone to obtain a mixture, 0.013 mL of methyl iodide and 0.2 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.46 g of a highly alkali-stable poly(arylene alkylene piperidinium) cationic polymer powder, with the structure shown as follows:

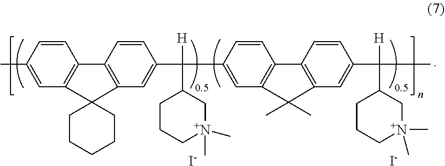

### Application Example 7

a. Replacement of the Counterions in the Cationic Polymer Powder

The counterions I⁻ in the highly alkali-stable poly(arylene alkylene piperidinium) cationic polymer prepared in Example 7 were exchanged as needed, the poly(arylene alkylene piperidinium) cationic polymer powder with counterions I⁻ was placed in a 2 mol/L NaOH solution and immersed for 48 h to obtain a mixture, and then the mixture was thoroughly washed with deionized water, and subjected to suction filtration to obtain the highly alkali-stable poly(arylene alkylene piperidinium) cationic polymer with counterions OH⁻.

b. Preparation of a Catalyst Layer Binder

The highly alkali-stable poly(arylene alkylene piperidinium) cationic polymer with counterions OH⁻ prepared in the step a was used as the catalyst layer binder with counterions OH⁻. The cationic polymer with counterions OH⁻ was dissolved in a mixed solvent of isopropanol and water with a solid content of 2 wt % and mixed with a metal catalyst to prepare a uniformly dispersed slurry which is a slurry using the cationic polymer in Example 7 as the catalyst layer binder.

### Example 8

S1, a polymerization mixture consisting of 3-piperidinecarboxaldehyde hydrochloride (0.19 g, 1.43 mmol) and bibenzyl (0.23 g, 1.29 mmol) was placed in dichloromethane (2 mL), trifluoromethanesulfonic acid (4.0 mL) was added for catalytic polycondensation, and the mixture was allowed to react at 22° C. for 40 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.37 g of a white fibrous polymer powder having piperidine moieties.

S3, the polymer powder having piperidine moieties in the S2 was dissolved in 5 mL of N-methylpyrrolidone to obtain a mixture, 0.19 mL of methyl iodide and 0.21 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.41 g of a highly alkali-stable poly(arylene alkylene piperidinium) cationic polymer powder, with the structure shown as follows:

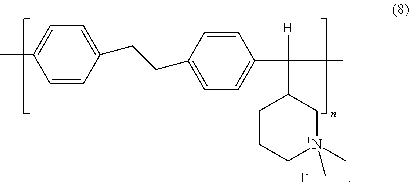

### Application Example 8

a. Replacement of the Counterions in the Cationic Polymer Powder

The counterions I⁻ in the highly alkali-stable poly(arylene alkylene piperidinium) cationic polymer prepared in Example 8 were exchanged as needed, the poly(arylene alkylene piperidinium) cationic polymer powder with counterions I⁻ was placed in a 2 mol/L NaOH solution and immersed for 48 h to obtain a mixture, and then the mixture was thoroughly washed with deionized water, and subjected to suction filtration to obtain the highly alkali-stable poly(arylene alkylene piperidinium) cationic polymer with counterions OH⁻.

b. Preparation of a Catalyst Layer Binder

The highly alkali-stable poly(arylene alkylene piperidinium) cationic polymer with counterions OH⁻ prepared in the step a was used as the catalyst layer binder with counterions OH⁻. The cationic polymer with counterions OH⁻ was dissolved in a mixed solvent of isopropanol and water with a solid content of 2 wt % and mixed with a metal catalyst to prepare a uniformly dispersed slurry which is a slurry using the cationic polymer in Example 8 as the catalyst layer binder.

### Example 9

S1, a polymerization mixture consisting of 3-piperidinecarboxaldehyde hydrochloride (0.39 g, 2.84 mmol), 9,9-dipropylfluorene (0.35 g, 1.29 mmol), and bibenzyl (0.23 g, 1.29 mmol) was placed in dichloromethane (5.0 mL), trifluoromethanesulfonic acid (8.0 mL) was added for catalytic polycondensation, and the mixture was allowed to react at 22° C. for 24 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.91 g of a white fibrous polymer powder having piperidine moieties.

S3, the polymer powder having piperidine moieties in the S2 was dissolved in a 4 mL of N-methylpyrrolidone to obtain a mixture, 0.66 mL of methyl iodide and 0.36 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 1.02 g of a highly alkali-stable poly(arylene alkylene piperidinium) cationic polymer powder, with the structure shown as follows:

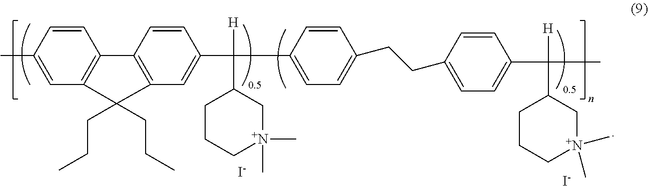

### Application Example 9

a. Replacement of the Counterions in the Cationic Polymer Powder

The counterions I⁻ in the highly alkali-stable poly(arylene alkylene piperidinium) cationic polymer prepared in Example 9 were exchanged as needed, the poly(arylene alkylene piperidinium) cationic polymer powder with counterions I⁻ was placed in a 2 mol/L NaOH solution and immersed for 48 h to obtain a mixture, and then the mixture was thoroughly washed with deionized water, and subjected to suction filtration to obtain the highly alkali-stable poly(arylene alkylene piperidinium) cationic polymer with counterions OH⁻.

b. Preparation of a Catalyst Layer Binder

The highly alkali-stable poly(arylene alkylene piperidinium) cationic polymer with counterions OH⁻ prepared in the step a was used as the catalyst layer binder with counterions OH⁻. The cationic polymer with counterions OH⁻ was dissolved in a mixed solvent of isopropanol and water with a solid content of 2 wt % and mixed with a metal catalyst to prepare a uniformly dispersed slurry which is a slurry using the cationic polymer in Example 9 as the catalyst layer binder.

### Example 10

S1, a polymerization mixture consisting of 3-piperidinecarboxaldehyde hydrochloride (0.13 g, 0.99 mmol), trifluoroacetophenone (0.03 g, 0.21 mmol), trifluoroacetone (0.02 g, 0.21 mmol), and spiro(cyclopentane-1,9′-fluorene) (0.31 g, 1.29 mmol) was placed in dichloromethane (8.0 mL), trifluoromethanesulfonic acid (14.0 mL) was added for catalytic polycondensation, and the mixture was allowed to react at 22° C. for 48 h to obtain a viscous dispersion of a polymer having piperidine moieties.

S2, the dispersion of the polymer having piperidine moieties in the S1 was slowly dropped into a 1:1 (v/v) mixed solution of methanol and water, and the obtained pale yellow fibrous polymer was filtered, washed thoroughly, and vacuum-dried to obtain 0.42 g of a white fibrous polymer powder having piperidine moieties.

S3, the polymer powder having piperidine moieties in the S2 was dissolved in 8 mL of N-methylpyrrolidone to obtain a mixture, 0.52 mL of methyl iodide and 0.24 g of potassium carbonate were added into the mixture, and the resulting mixture was subjected to a quaternization reaction at room temperature for 72 h to obtain a cationic polymer solution.

S4, the cationic polymer solution in the S3 was slowly added into diethyl ether to obtain a mixture, the mixture was filtered, and the filtered precipitate was dried to obtain 0.45 g of a highly alkali-stable poly(arylene alkylene piperidinium) cationic polymer powder, with the structure shown as follows:

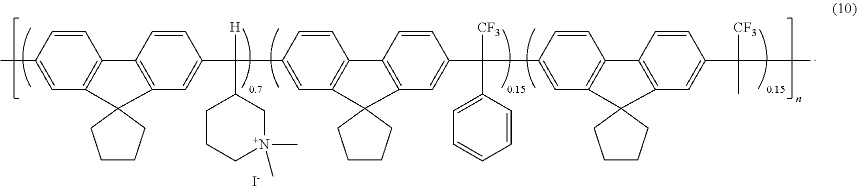

### Application Example 10

a. Replacement of the Counterions in the Cationic Polymer Powder

The counterions I⁻ in the highly alkali-stable poly(arylene alkylene piperidinium) cationic polymer prepared in Example 10 were exchanged as needed, the poly(arylene alkylene piperidinium) cationic polymer powder with counterions I⁻ was placed in a 2 mol/L NaOH solution and immersed for 48 h to obtain a mixture, and then the mixture was thoroughly washed with deionized water, and subjected to suction filtration to obtain the highly alkali-stable poly(arylene alkylene piperidinium) cationic polymer with counterions OH⁻.

b. Preparation of a Catalyst Layer Binder

The highly alkali-stable poly(arylene alkylene piperidinium) cationic polymer with counterions OH⁻ prepared in the step a was used as the catalyst layer binder with counterions OH⁻. The cationic polymer with counterions OH⁻ was dissolved in a mixed solvent of isopropanol and water with a solid content of 2 wt % and mixed with a metal catalyst to prepare a uniformly dispersed slurry which is a slurry using the cationic polymer in Example 10 as the catalyst layer binder.

Therefore, the present disclosure provides highly alkali-stable poly(arylene alkylene piperidinium) cationic polymers having the above structure, and preparation methods and applications. The cationic polymer prepared by the present disclosure may be used as a membrane material in various fields such as fuel cells and water electrolysis, and moreover, the cationic polymer may also be used as the catalyst binder material for catalyst layers of fuel cells and water electrolysis.

It should be noted finally that the above examples are merely used to describe the technical solutions of the present invention, rather than limiting the same; although the present disclosure is described in detail with reference to the above examples, those of ordinary skill in the art should understand that they still can modify or equivalently replace the technical solutions in the above examples, and these modifications or equivalent replacements shall not cause the modified technical solutions to depart from the spirit and scope of the technical solutions of the present invention.

What is claimed is:

1. Alkali-stable poly(arylene alkylene piperidinium) cationic polymers, comprising the following structural subunits: 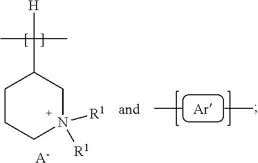
wherein R¹ is selected from an H atom or a hydrocarbyl group with 1-20 carbon atoms, or wherein both R¹ groups are connected to each other to form a cycloalkyl group consisting of 4 to 10 carbon atoms; and wherein the counterion A⁻ is selected from one or more of halide ions, methyl sulfate ions, hydroxide ions, or bicarbonate ions; and
wherein the Ar′ unit is selected from one or more of the following structures:

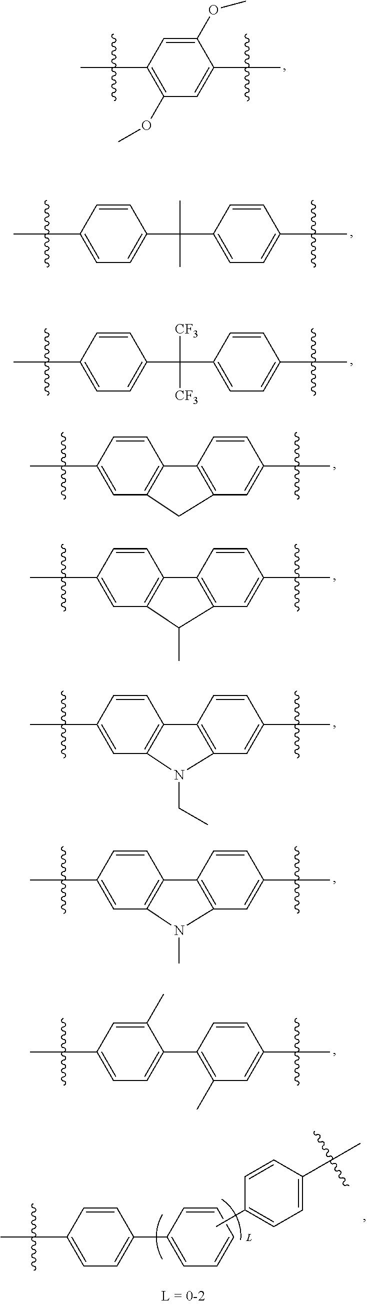

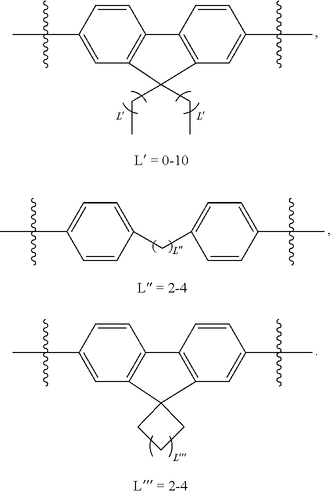

2. The alkali-stable poly(arylene alkylene piperidinium) cationic polymers according to claim 1, further comprising one or more of the following structural units: 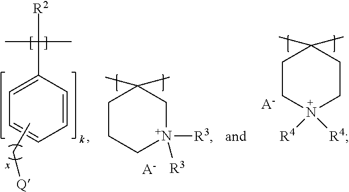
wherein k=0 or 1; and x=0-12;
R² is independently selected from a hydrogen atom, a hydrocarbyl group with 1-20 carbon atoms, or a fully or partially fluorinated alkyl group with 1-6 carbon atoms;
Q′ is selected from one or more of H, —N⁺(R⁵)₃, or a nitrogen heterocycle-containing cationic group, and the counterion A⁻ is selected from halide ions, methyl sulfate ions, hydroxide ions, and bicarbonate ions; and
wherein R³ is selected from an H atom or a hydrocarbon group with 1-20 carbon atoms, or wherein both R³ groups are connected to each other to form a cycloalkyl group consisting of 4 to 10 carbon atoms;
wherein R⁴ is selected from an H atom or a hydrocarbon group with 1-20 carbon atoms, or wherein both R⁴ groups are connected to each other to form a cycloalkyl group consisting of 4 to 10 carbon atoms.

3. A preparation method for the alkali-stable poly(arylene alkylene piperidinium) cationic polymers according to claim 2, comprising the following steps:
S1, mixing 1-R⁶-piperidine-3-carboxaldehyde or its salt or hydrate thereof with aromatic compounds to obtain a polymerization compound mixture, placing the polymerization compound mixture in a first organic solvent, and adding a strong organic acid for catalytic polycondensation to obtain a polymer dispersion with piperidine moieties;
S2, slowly dropping the polymer dispersion with the piperidine moiety in the S1 into a first precipitant, filtering, washing, and drying to obtain a polymer powder with piperidine moieties;
S3, dissolving the polymer powder with the piperidine moieties in the S2 in a second organic solvent to obtain a mixture, adding quaternization reagents into the mixture, obtaining a cationic polymer solution after a quaternization reaction at 0-100° C. for 0.1-100 h; and
S4, slowly adding the cationic polymer solution in the S3 into a second precipitant, filtering and drying the filtered precipitate to obtain a poly(arylene alkylene piperidinium) cationic polymer powder.

4. The preparation method for the alkali-stable poly(arylene alkylene piperidinium) cationic polymers according to claim 3, wherein in S1, a structural formula of 1-R⁶-piperidine-3-carboxaldehyde is shown as follows: 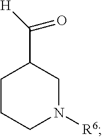
wherein, in the formula, R⁶ is selected from one or more of an H atom or a hydrocarbyl group with 1-20 carbon atoms.

5. The preparation method for the alkali-stable poly(arylene alkylene piperidinium) cationic polymers according to claim 3, wherein in S1, the polymerization compound mixture further comprises carbonyl monomers, and the carbonyl monomers have one or more of the following structures: 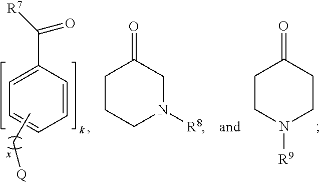
wherein, in the formula, k=0 or 1; x=0-12;
Q is selected from one or more of an H atom or a halogen atom;
R⁷ is selected from one or more of an H atom, a hydrocarbyl group with 1-20 carbon atoms, or fully or partially fluorinated alkyl groups with 1-6 carbon atoms; and
wherein R⁸ and R⁹ are each independently selected from an H atom or a hydrocarbyl group with 1-20 carbon atoms.

6. The preparation method for the alkali-stable poly(arylene alkylene piperidinium) cationic polymers according to claim 3, wherein in S1, the molar ratio of the 1-R⁶-piperidine-3-carboxaldehyde or a salt or hydrate thereof to the strong organic acid is 1:(1-20).

7. The preparation method for the alkali-stable poly(arylene alkylene piperidinium) cationic polymers according to claim 5, wherein in S1, the ratio of the sum of the molar amounts of 1-R⁶-piperidine-3-carboxaldehyde or a salt or hydrate thereof and carbonyl monomers to the molar amounts of strong organic acid is 1:(1-20).

8. The preparation method for the alkali-stable poly(arylene alkylene piperidinium) cationic polymers according to claim 3, wherein in S3, the quaternization reagent is dimethyl sulfate or halogenated hydrocarbons with 1-20 carbon atoms having a structure of: 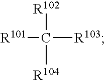
wherein R¹⁰¹, R¹⁰², R¹⁰³, and R¹⁰⁴ are each independently selected from hydrogen, halogen, hydrocarbyl groups or halohydrocarbyl groups with 1-20 carbon atoms, or aryl groups or halogenated aryl groups with 1-20 carbon atoms, and the halohydrocarbyl groups or halogenated aryl groups contain at least one halogen atom.

9. The preparation method for the alkali-stable poly(arylene alkylene piperidinium) cationic polymers according to claim 3, wherein the poly(arylene alkylene piperidinium) cationic polymer powder in S4 is immersed in a solution containing other types of counterions for ion exchange to obtain a cationic polymer containing other types of counterions.

10. A method of use of the alkali-stable poly(arylene alkylene piperidinium) cationic polymers according to claim 2, wherein an alkali-stable poly(arylene alkylene piperidinium) cationic polymer is applied to an anion exchange membrane or a catalyst layer binder.
